(19) United States
(12) Patent Application Publication
(10) Pub. No.: US 2016/0314794 A1
(43) Pub. Date: Oct. 27, 2016

(54) SYSTEM AND METHOD FOR CONTINUING AN INTERRUPTED BROADCAST STREAM

(71) Applicant: SoundHound, Inc., Santa Clara, CA (US)

(72) Inventors: Victor Leitman, San Jose, CA (US); Bernard Mont-Reynaud, Sunnyvale, CA (US); Kathleen Worthington McMahon, Redwood City, CA (US); Regina Collecchia, Santa Clara, CA (US)

(73) Assignee: SoundHound, Inc., Santa Clara, CA (US)

(21) Appl. No.: 15/098,080

(22) Filed: Apr. 13, 2016

Related U.S. Application Data
(60) Provisional application No. 62/153,335, filed on Apr. 27, 2015.

(51) Int. Cl. G10L 19/018; H04H 20/86

(52) U.S. Cl. CPC G10L 19/018; H04H 20/86

(57) ABSTRACT

A client, such as a mobile phone, receives an audio signal from a microphone; the sound comes from a broadcast signal such as a radio or television program. The client sends a segment of audio data from the broadcast program to a detection system, such as a server. A broadcast monitoring system receives many broadcast audio signals and encodes their fingerprints in a database for matching. The detection system compares the client's audio data fingerprints to the content fingerprints to identify which broadcast station broadcast the signal having the sampled content. This information enables the client to resume the experience of the broadcast from one of a number of possible media sources.

### RELATED APPLICATIONS

This application claims priority from U.S. Provisional Application No. 62/153,335, filed on Apr. 27, 2015, entitled, “SYSTEM AND METHOD FOR CONTINUING AN INTERRUPTED BROADCAST STREAM,” (Attorney Docket No MELD 1029-1), naming inventors Kathleen McMahon, Victor Leitman, Bernard Mont-Reynaud, and Regina Collecchia. This application is also related to U.S. application Ser. No. 13/401,728 filed on Feb. 21, 2012, entitled “SYSTEM AND METHOD FOR MATCHING A QUERY AGAINST A STREAM”, naming inventors Keyvan Mohajer, Bernard Mont-Reynaud, and Joe Aung. Both applications mentioned above are hereby incorporated by reference.

### TECHNICAL FIELD

The disclosed embodiments relate generally to the playback of audio, video, or other data streams, and more specifically, to various techniques for allowing a recipient of a broadcast stream to resume a temporal experience that has been interrupted.

### BACKGROUND

Listening to a broadcast of a radio or television program can be a deeply engaging experience for a user. Such experiences are sometimes interrupted, such as when a baby needs immediate attention, when arriving at a destination in the middle of enjoying the experience in transit, or whenever having to walk away from a radio or television. In some cases, it is possible to resume the program later from recorded data, such as a podcast or online video, but it may be difficult or inconvenient to find the data, or the position at which the program was interrupted. In some cases, it is possible to continue the program by tuning to another receiver of the broadcast, but that is inconvenient as well.

In another situation, a listener discovers an engaging broadcast, but has missed the beginning of it. Even though it is technically possible to replay the broadcast from a podcast or online video, it may be difficult or inconvenient for the listener to locate the stored data.

In these situations, the temporal experience is less than optimal. For example, John drives home from work while listening to a broadcast of a fascinating interview by Terry Gross on the radio program “Fresh Air.” He is only 25 minutes into a one-hour broadcast when he gets home. John could stay in the car until the end of the hour, which would be awkward and inconvenient. He could leave the car and wait until the episode of Fresh Air becomes available as an Internet podcast, but that might not occur for a long time, and he would find it difficult to pick up at the program position where he left off. To do so, he would have to note the position within the program and the date. If the broadcast is a rerun then the important date is not the current date, but that of the original broadcast. The date of the original broadcast was mentioned at the beginning of the program, but John did not write it down while driving.

Such problems are not limited to radio programs. Television programs, movies, and other temporal experiences all place much importance on their progression within time.

### SUMMARY

A broadcast recognition system according to U.S. patent application Ser. No. 13/401,728 can identify broadcast sources from a few seconds of audio, and determine the time position of the segment of audio within the broadcast stream. We propose several solutions to the problem of resuming the experience of a broadcast after an interruption. Some of the solutions offer additional functionality, such as playback control options.

The present invention is directed to systems and methods for resuming identifiable broadcast streams. These are media streams that the user cannot pause. Some examples are radio broadcasts, television broadcasts, webcasts, and Internet radio streams. The invention can be fully embodied in each of servers, clients, and the interactions of any combination of servers, clients, and users.

According to an aspect of the invention, a user operates a client device that comprises a microphone. In some embodiments, the client is a smartphone with an application program (app) installed. According to another aspect of the invention, one or more servers monitor a number of broadcast sources. According to some embodiments, broadcast signals come from radio stations, television stations, Internet stations, or any source of media content that a user has no control to pause, reposition or resume. A server (or a plurality of servers) maintains a database that stores station data, including static metadata about the station, and fingerprints for live broadcast audio signals. The client captures audio segments from a microphone and sends a corresponding query to the server. Matching audio fingerprints between client audio segments and monitored station audio signals can be used to identify the broadcast station that originated the signal. Based on the station's metadata, this may lead to one or more ways to support the continuation of the user's listening experience. Multiple alternative scenarios will be described.

The information sent by the client to the server for purposes of identifying a station is known as a query. In various embodiments, a query comprises one or more of: a sampled audio segment, a compressed audio segment, or a fingerprint sequence that the client computes from the sampled audio segment. Note that the terminology for fingerprints can be confusing: the fingerprint of a segment of audio may be a fingerprint sequence, with one fingerprint element per time frame. In this disclosure, the terms “fingerprint” and “fingerprint sequence” are used interchangeably.

In various embodiments, the query metadata may include client context information such as a timestamp, the client's location, a user profile or user preference data, or input from a sensor on the client. A query elicits a response from the server. The server receives the query, decompresses the audio segment, if necessary, and computes an audio fingerprint if necessary. The server runs a broadcast stream recognition system. The broadcast stream recognition system uses a fingerprint database, and looks for a match between the client's fingerprint sequence and a fingerprint sequence among the fingerprint sequences of the monitored broadcasts. If a match has been achieved, the response from the server may include one or more of: an identification of the broadcast station; an identification of a radio or TV program; an identification of a music title or album; and other information indicating possible ways for continuing to experience the content from the client device. In some embodiments, the user commands a portable client to switch to a substitute content source on the fly.

According to some embodiments, the client comprises a programmable tuner. In response to a user's request via a client app, the recognition server identifies a station, and then instructs the client to set the frequency of the programmable tuner to that of the identified station. This enables the user to leave the car, and continue listening to the broadcast through the speaker of the mobile client device. The user's listening experience then continues without a hitch. In some embodiments the user makes a request to a client operating system.

In some embodiments the client identifies a need to program and enable its tuner without a user request. The client is always listening, and enables the tuner when the broadcast audio becomes faint. When the client is playing broadcast audio, and hears the same broadcast from another source through its microphone, then the client disables its tuner. This is useful if, for example, a user listening to a broadcast on a portable client walks into a room or turns on a car radio playing the same broadcast. In such case, the portable client, by turning off its own turner, can conserve its battery energy. One method to distinguish broadcast audio of an external source from broadcast audio received from its own speaker is for the client to add a small delay to its speaker audio output.

In some embodiments, the server provides the client with information that identifies the source of a live Internet broadcast stream for the identified station, if such a broadcast stream exists. In some embodiments, when a broadcast stream is identified, the client accesses an on-demand broadcast stream for the broadcast content.

In some embodiments, a server stores stream sources for this purpose. In some embodiments, the server sources media streaming content from a third party. In some embodiments, the server provides playback controls such as pause, rewind, and fast-forward to the user, through the client. In some embodiments, the client downloads a media file, either from the server or from a third party, stores it in a local non-transitory medium, and plays the media file on demand.

### BRIEF DESCRIPTION OF THE DRAWINGS

FIG. 1 illustrates a system according to an embodiment of the invention.

FIG. 2 illustrates the high-level organization of a broadcast database, according to an embodiment of the invention.

FIG. 3 illustrates the structure of the data associated with a single broadcast station in a broadcast database, according to an embodiment of the invention.

FIG. 4 illustrates the operation of a broadcast monitoring system, according to an embodiment of the invention.

FIG. 5 illustrates a detection system including fingerprinting of client captured audio data and fingerprint matching against a database, according to an embodiment of the invention.

FIG. 6 illustrates the elements and interaction between client and detection system, according to an embodiment of the invention.

FIG. 7 illustrates client and detection system interaction for an embodiment with a client that comprises an internal tuner.

FIG. 8 illustrates client and detection system interaction for an embodiment with Internet streaming of content to the client.

FIG. 9 illustrates client and detection system interaction for an embodiment in which the client comprises an Internet radio player.

FIG. 10 illustrates client and detection system interaction for an embodiment in which the client comprises a media player.

FIG. 11 illustrates flowchart of continuing a listening experience, according to an embodiment of the invention.

The figures depict various embodiments of the present invention for purposes of illustration only. One skilled in the art will readily recognize from the following description that alternative embodiments of the structures and methods illustrated herein may be used without departing from the principles of the present invention.

### DETAILED DESCRIPTION

U.S. patent application Ser. No. 13/401,728 describes systems and methods to detect and identify a broadcast station (or stream) that a client hears. Some such systems are able to timestamp the point at which the user has captured the stream for recognition. Using additional data if needed, some embodiments of the present invention are able to give users options for “putting on hold” and later resuming a program after its interruption. For example, when a user leaves her car, so that her car radio becomes unavailable as an audio play source, some embodiments of the invention can save sufficient information to continue the program uninterrupted from a client device such as a mobile phone. Some embodiments save sufficient information to resume the program later, at the same position. Some embodiments provide for a user to indicate an amount of rewinding from the position, which can help re-establish the context of the program. Some embodiments use resources such as available alternative stream sources. Some embodiments assume that the position of the last captured audio received from the client and successfully identified marks the position of the interruption. Such embodiments use that position as a reference timestamp for the beginning of a new listening session. Some embodiments use a default, but user settable, amount of rewinding before starting to play the program again.

For purposes of illustration, we use audio as the exemplary medium for identifying broadcast sources; the audio that a user listens to may come from a radio station, a TV station, or another stream source. Note that the present invention may be implemented for generalized data streams, including audio, video and other data, such as subcarrier metadata. The corresponding fingerprint sequences may be generated from these generalized stream signals and subsequently matched, in much the way the disclosure handles audio. A person skilled in the art will readily see how to transpose the techniques presented to media other than audio.

Digital audio transmission systems may compress audio signals using an audio codec. However, for the purpose of comparing “similar-sounding” audio segments, systems may pre-process audio segments to generate a fingerprint sequence (also called “signature” or “robust hash”). The fingerprints of two audio segments can be compared to determine how similar the two audio segments are to each other. Fingerprinting is closely related to perceptually-based compression. Both rely on compact representations of audio signals. However, whereas codecs seek to maximize the quality of signal reconstruction, fingerprints seek to optimize precision and recall during recognition. When matching a query of sufficient length, the precision of recognition is very high. That is true for both audio and video signals. The audio and image components of video can be fingerprinted separately, or the fingerprints combined. Audio fingerprints give information about broadcast content in a compact form that allows accurate identification.

A broadcast monitoring system receives audio from multiple broadcast sources, segments the audio received from an audio source into blocks, computes fingerprints for each block, and indexes the fingerprints by broadcast source and a universal timestamp. Small block sizes allow a lower detection latency, but greater overhead in storage and processing requirements. A block size on the order of one second is reasonable.

In some embodiments the system aggregates the fingerprints into fingerprint buffers. A fingerprint buffer contains the fingerprints of a single broadcast channel over a particular length of time, such as one hour or one day. Some embodiments comprise a signal buffer that stores digital signal data corresponding to a particular length of time; in an example embodiment, 30 seconds of radio fingerprints stored; in another, 6 hours of TV audio fingerprints are stored; with the current availability of cheap storage, it is quite practical to store weeks of fingerprinted material. The system then processes the data in the signal buffer and stores it in a fingerprint buffer, routinely discarding the oldest fingerprint data in the fingerprint buffer.

The “real-time” timing reference for live content is the point in time of broadcasting the stream signal from a broadcast station, through radio waves or via Internet. There may be a delay between the real-time signal and the time at which broadcast station fingerprints are available to the server, due to latency in the broadcast monitoring system for signal capture and fingerprint generation. These delays cannot be eliminated, but they can be accurately tracked with timestamping. The same is true on a client. Delay occurs between the real-time reference and the reception of fingerprints on the server that performs the matching of fingerprints for station identification; the delays are due to signal capture, fingerprint generation and data transmission. In embodiments that require near continuity during a hand-off, it is important to minimize both types of delay (server-side and client-side). The presence of a gap could cause the loss of an important understanding or appreciation of the program.

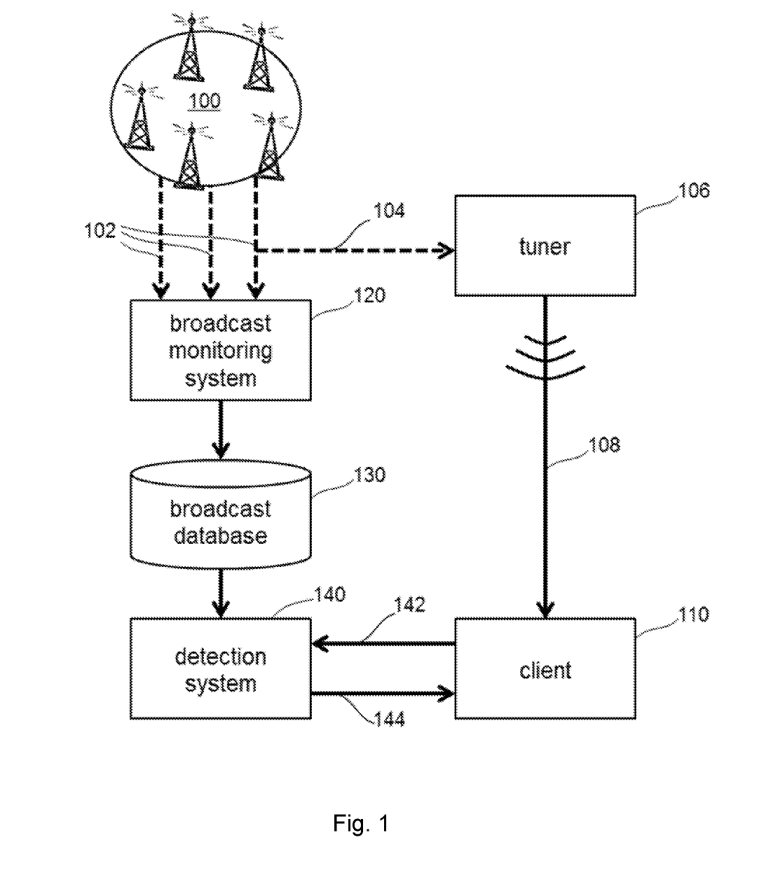

FIG. 1 shows a system according the present invention. Various broadcast stations 100 are monitored; they broadcast signals 102. A particular broadcast station among the monitored stations broadcasts the signal 104 that a tuner 106 is tuned into. Tuner 106 derives from signal 104 an audio signal 108, which is played through a loudspeaker. A client device 110 receives the audio signal 108 by way of a microphone, because device 110 is within hearing distance of tuner 106, which may be a radio tuner or a television tuner that captures broadcast signal 104 and plays audio signal 108 through a speaker.

Broadcast monitoring system 120 captures a set of broadcast signals 102, including the signal 104 that tuner 106 is tuned to. It extracts the audio from each signal, and uses the audio to create fingerprints that will help identify broadcast stations 100 by their audio content. Broadcast monitoring system 120 associates these fingerprints and related data for the monitored stations, and stores them in a broadcast database 130. Database 130 provides data that support matching of audio signals captured by a client 110 with audio signals from any of the monitored stations, in order to identify which station is responsible for broadcasting signal 104.

Client 110 captures the data with one or more sensors, such as microphones for audio. Client 110 has the ability to (1) capture audio signal 108 received from tuner 106, (2) convert the audio signal to audio data, and (3) send a query to detection system 140 through network connection 142. In various embodiments, the audio data is sampled audio, compressed audio, or audio fingerprints. In various embodiments, client 110 performs steps (1-3) only when the user issues a command, automatically at certain intervals, or continuously.

Detection system 140 identifies which broadcast station 100 is the source of the audio signal 108 received by client 110. The audio data received through network connection 142 is converted (if necessary) to audio fingerprints. Detection system 140 searches the broadcast database 130 in an attempt to match client audio fingerprints with live content fingerprints. Detection system 140 sends match information to client 110 through network connection 144. Various embodiments enable and perform different flows for exchanging data between client 110 and detection system 140.

In some embodiments, broadcast signals 102 and 104 include subcarrier data. In an embodiment for FM radio, examples are Radio Data System (RDS) data, or other systems that encode the name of a program, the name and call sign of a broadcast station, and the name of a song. In an embodiment for TV, some examples of subcarrier data are captions, datacasting, and MPEG-2 transport stream data encapsulation. Broadcast monitoring system 120 stores subcarrier data in the broadcast database. Though subcarrier data may be undetectable in audio signal 108, detection system 140 can transfer such data through network connection 144 to client 110.

Audio signal 108 comprises environmental noise mixed with the audio output from tuner 106, and the signal is also possibly affected by distortion. In an embodiment, client 110 performs preprocessing of the signal, such as noise filtering on the audio signal. In an embodiment, the client uploads sampled audio over network connection 142. In another embodiment, the client uploads compressed audio data; in yet another embodiment, the client computes and uploads audio fingerprints derived from the captured audio. In some embodiments, the client uploads other contextual information, such as location, user demographic information, user preferences, etc., to detection system 140 along with the audio data.

In various embodiments, broadcast database 130 is stored on one server, multiple servers, or a data center, and detection system 140 may use a single server or be distributed. In various embodiments, broadcast monitoring system 120 may use a server, or be distributed across multiple servers, as appropriate for the physical locations of broadcast stations 100 and the size of the broadcast database 130, and detection system 140 may use the same servers as broadcast monitoring system 120, or different servers.

In one embodiment, broadcast stations 100 are radio stations. The sensors used by the broadcast monitoring system 120 comprise, for example, an array of programmable radio tuners that capture audio from selected broadcast stations 100. In another embodiment, the broadcast stations 100 may be television stations, and the broadcast monitoring system 120 uses an array of programmable TV tuners, configured to record (at least) audio in a suitable format. In another embodiment, a HD radio tuner also captures, in addition to the signal content, useful metadata such as a program name, or title of content such as a song or interview. In another embodiment, radio or TV is captured via Internet streams. In every embodiment, broadcast monitoring uses appropriate sensors to capture signals. Much of the station metadata is not broadcast with the signal content, and it never or infrequently changes: station name, broadcast frequency, program guide, or URL's for retrieving the program guide or the recent playlists may be statically stored in the broadcast database, as well as appropriate protocols to acquire additional metadata when available, perhaps through other channels, such as a station's website, or datacasting.

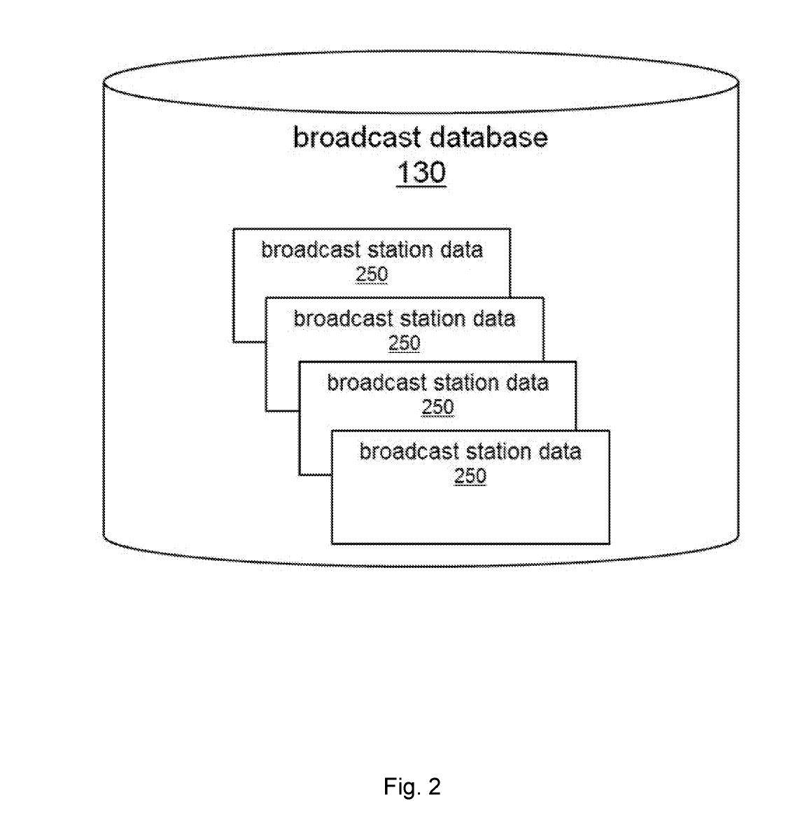

FIG. 2 illustrates the high-level organization of a broadcast database 130, according to an embodiment of the invention. Database 130 comprises an instance of broadcast station data 250 for each monitored broadcast station. Each instance of broadcast station data 250 is a container for the information that pertains to one monitored broadcast station. Some of the data involves live content, which is preserved for a relatively short amount of time, from a few minutes to a few days, depending on the application and the amount of storage available. There are many ways to structure and organize the broadcast station data 250, any of which a person skilled in the art will find apparent after reviewing the present disclosure, beyond any examples shown in this document.

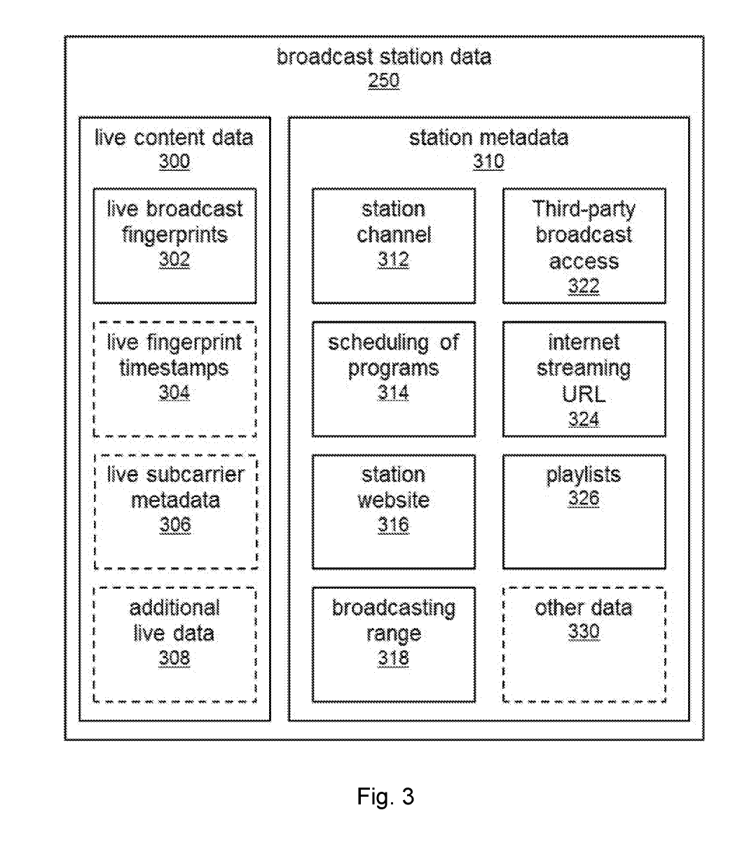

FIG. 3 illustrates a way to organize broadcast station data 250 associated with one of the monitored broadcast stations 100, according to an embodiment. A large part of the information in FIG. 3, live content data 300, is derived in real-time from the broadcast signal content. Another part of the information, the station metadata 310, is smaller in size but important for applications. Much of the information may be available from a broadcast station's website. Some high-level information, such as the list of monitored stations, may be entered manually by a system administrator. The live content-related data 300 is subject to continuous change in real-time. Live content data 300 comprises live broadcast fingerprints 302 for the streaming audio (and perhaps other media) and possibly other data.

In an embodiment, fingerprints 302 have associated timestamps 304. These timestamps are optional because they are somewhat redundant. Since they predictably mimic the passage of time, timestamps can be calculated by tracking the current position in the fingerprint stream from a single initial timestamp. Whether they are derived from stored timestamps 304, or recalculated as just described, timestamps allows the determination of a temporal position, with sufficient accuracy that it is feasible to resume an interrupted listening experience precisely from the point of interruption—within more than acceptable limits, such as fraction of a second. Note the program offset, if needed, can be computed from the timestamp and station metadata such as the schedule of programs 314.

In some embodiments, a broadcast signal includes subcarrier data that encode metadata such as a music title (or song name), an artist name, or the name of the program. When such data is present, it may be decoded and stored as live subcarrier metadata 306. In some embodiments, additional live data 308 may also be stored as part of the live content data 300.

In contrast with live content data, station metadata 310 comprises static parts, and other parts that are only updated infrequently (e.g., a few times per day or per hour). Station metadata 310 includes: an identity of the station channel 312, specified at least by name (e.g., KQED) and by frequency (e.g., FM 66.5). In an embodiment, station metadata 310 includes a schedule 314 for the station's programs; a website 316 for the station; the broadcasting range 318 of the station, describing the geographical locations served by the broadcast station; and more, to be described soon. In some embodiments, the broadcasting range will be used by a station detection system 140 to restrict its search to local stations (stations that match the user location information provided by the client) or at least to favor local stations over remote, stations that might be received via Internet.

The station metadata 310 for a station may also include links 322 that give access to third party (alternative) sources 222 for the broadcast content, as well as Internet live streaming URLs 324, playlists 326 for music programs, and possibly other data 330 that are not described in this exemplary version of the broadcast station data.

Broadcast station data 250 only stores a range of the most recent data collected from live content, limited by storage availability or more often, dictated by the needs of an application. In some embodiments, broadcast station data 250 may allocate a fixed amount of storage for each broadcast station 100. One implementation uses circular buffer storage areas, where old data is discarded after a certain amount of time, such as a few minutes, or one day, and the freed space is reused thereafter. The appropriate duration of data retention varies with the system and the application.

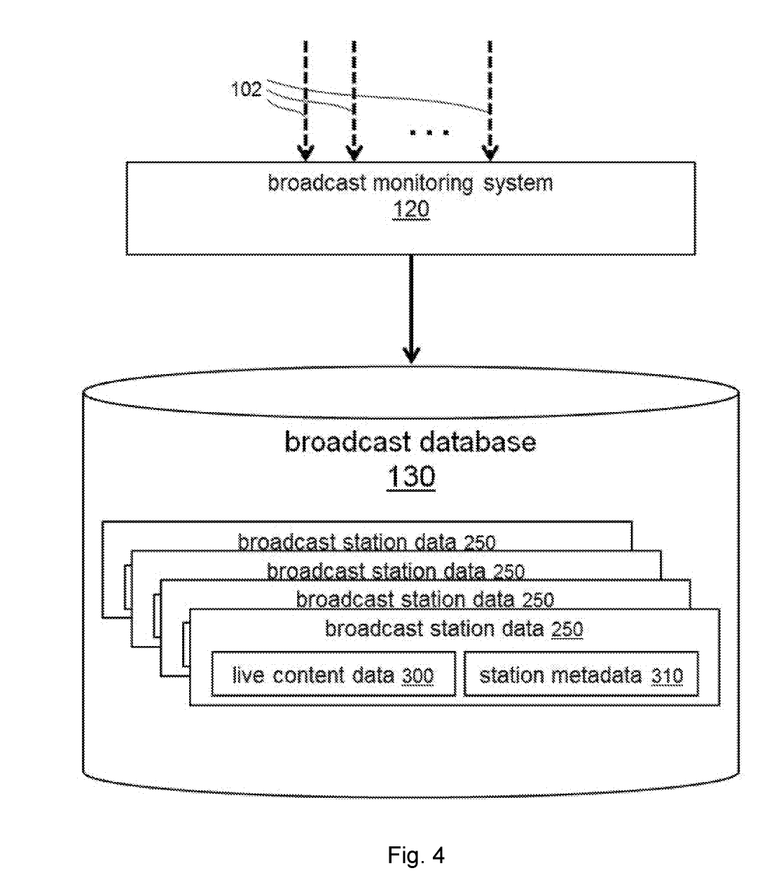

FIG. 4 illustrates the operation of the broadcast monitoring system 120, according to an embodiment of the invention. The role of the broadcast monitoring system 120 is to provide the data for the broadcast database 130. The broadcast monitoring system is programmed to receive a known collection of broadcast signals 102. For each broadcast signal, monitoring system 120 creates live content data 300, including at least live broadcast fingerprints 302, shown in FIG. 3. The broadcast monitoring system 120 may also, at suitable intervals, generate live fingerprint timestamps 304 along with the fingerprint sequences 302. Timestamps are preferably expressed as universal time, to facilitate comparisons across different time zones. Since timestamps may also be reconstructed from a timestamp origin, a convenient approach used in some embodiments is to only store timestamps 304 at the beginning of large blocks of fingerprint data.

When subcarrier information exists in the broadcast signals 102, the broadcast monitoring system 120 is able to extract from the signal and decode live subcarrier metadata 306. Matching subcarrier metadata 306 between a monitored broadcast signal and a signal captured by a client 110, when both exist, provides a fast way to detect mismatches, and time-approximate matches. Some embodiments do not extract such metadata from the subcarrier data in broadcast signals. Instead, stations may give access to roughly equivalent metadata, such as song titles, via URLs that can be used to retrieve on demand metadata such as (timed) playlists. Broadcast monitoring system 120 generates live content data 300 that includes fingerprints 402 and optional data such as timestamps 304, subcarrier metadata 306 and additional live data 308. The live content data 300 is sent (presumably, streamed) streamed to broadcast database 130.

Regarding station metadata 310, an embodiment of the station metadata 310 has static components, such as station channel data 312 (channel name and frequency), broadcasting range 318, station website 316 and access URLs (322, 324); this data may be fixed, assigned at system setup, and occasionally edited by a system administrator. The station metadata 310 also has components (such as a program schedule 314 and playlists 326) that can be manually edited, or automatically generated. An example of automatically generated (part of the other data 330) is data that tracks the times of broadcasting pre-recorded ads. These are examples that illustrate the richness of the station metadata 310. In some embodiments, further details are required, e.g., for full access to third party broadcast content 322. Thus, the contributions of broadcast monitoring system to the station metadata portion of the broadcast database 130 are discrete, infrequent, and of a relatively small size. This is in sharp contrast with the processes that generate live content data 300. As a result of creating and maintaining both live content data 300 and station metadata 310 using the processes just described, the broadcast database 130 is ready for use in broadcast source matching applications, by a detection system 140.

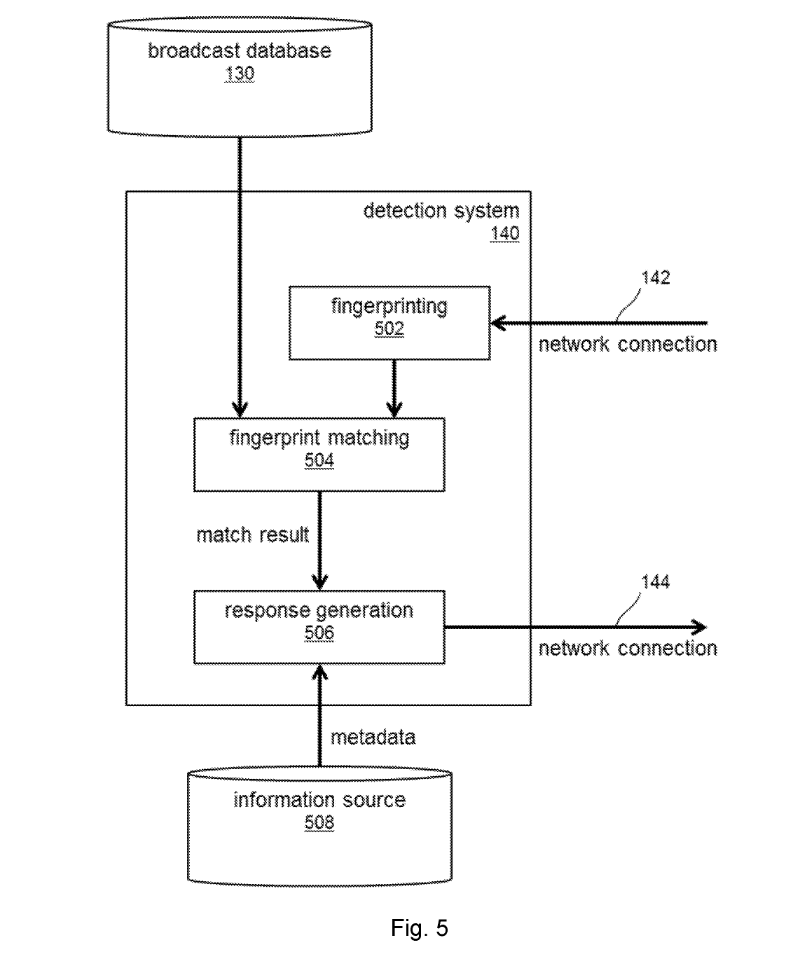

FIG. 5 illustrates an embodiment of the detection system 140. In the embodiment shown, detection system 140 receives an audio segment through a network connection 142 and creates corresponding fingerprints using its fingerprinting module 502. In a variant embodiment, client 110 has a local fingerprinting module to create the needed fingerprints from audio captured on the client. Whether or not the client 110 provides fingerprints for the client's audio content, the fingerprinting module 502 outputs needed fingerprints to the detection system 140. Fingerprint matching module 504 then proceeds to compare the client fingerprints from module 502 with any of the station fingerprints retrieved from broadcast database 130, used as reference fingerprints, and to select a best match. A comparison, scoring and selection may be performed by a convolution-like technique known to those in the field, whereby client audio fingerprints are run against reference audio fingerprints in all the allowed alignments; a match score is obtained for each alignment. The score for a reference is then set to the best score across all alignments. The best reference is selected as the reference with the best score. Beyond the well-known convolution-like matching and selection, additional factors may play a role, such as minimizing the time offset of the client audio from an expected time offset between client audio and reference audio; for example, when both audio signals derive from the same broadcast, they are expected to be almost synchronous, but processing and transmission delays on either the monitoring side or the client side can cause time misalignment, within bounds. In an embodiment, an average offset value is determined, and deviations from the average are somewhat penalized in the final score of a reference. A person in the art will easily find variations of such schemes.

As a result of matching, scoring and selection, fingerprint matching module 504 determines a best match (or in some embodiments more than one strong match) and forwards the resulting matches to response generation module 506. In some embodiments, ambiguous matches are first disambiguated using context variables such as location, as explained below. In some embodiments, response generation module 506 receives metadata from external information source 508. Following selection, response generation module 506 formats a response based on the match result, and including the metadata, as appropriate for client 110, and sends the response to the client over network connection 144.

According to different embodiments, fingerprint matching module 504 performs its search in various ways. In some embodiments the search proceeds through sets of live content fingerprints 402 in order, then through fingerprints within the set in order over a reasonable time range. The order of fingerprints may be simply chronological in a forward or reverse direction. Alternatively, shorter fingerprint segments may be ordered for search according to various criteria. Some embodiments search fingerprints for common jingles or theme songs first. In some embodiments, sets of live content fingerprints 402 are searched sequentially in order, and in some embodiments searches of live content fingerprints simultaneously on different processors.

In some embodiments, response generation module 506 associates live content fingerprints 302 or parts of station metadata 310 with popularity and user preference statistics. Other embodiments, instead, associate demographic data, derived from contextual or other information. For example, if detection system 140 is aware of a user's age, the fingerprint matching module 504 may give a higher priority to searches in the monitored broadcast fingerprint database 130 to stations known to be popular among that demographic.

The association weights their detection priority, which makes earlier detection more likely, and boosts the performance of detection system 140. According to some embodiments, broadcast database 130 makes popularity and preference statistics accessible via the other data 330 component of the broadcast station data 250, and provide the data to detection system 140 along with fingerprint data. Preference statistics can be gathered from user profile information or curated by a database owner. Popularity statistics can be derived from the number of searches that hit each broadcast station; other statistics are available from third parties. Such data allows fingerprint matching module 504 to select a search order that minimizes computation. Some embodiments accumulate popularity statistics by counting the number of query results for each station. Some embodiments access such data from other sources, such as Nielsen ratings.

Detection system 140 receives user data, and in some embodiments contextual information, from network connection 142. Some examples of contextual information are GPS location, native language, primary spoken language, age, gender, user name or account name, and user preferences regarding broadcasts. In one embodiment, the detection system may rely on user profile information included with the contextual information and a history of the user's activity to prioritize searches of broadcasts associated with features of the user's profile and behavior. Some such behavior is a history of query results from a particular device. Other such behavior is identifiable from one or more online or social media profiles connected with the device. Profiles can include data such as online message posting, email content, or the content of conversations.

In various embodiments, contextual information is helpful for restricting or prioritizing the set of possible broadcast station data 250 to search in the monitored broadcast database 130. For example, the client's GPS location is useful for detection systems 140 to focus its search in preference to broadcast stations that are available within certain geographical areas. Filtering broadcast stations by location and other contextual information thereby improve both the speed and accuracy of broadcast station recognition.

In some embodiments, client 110 performs fingerprinting. In some embodiments, detection system 140 performs fingerprinting. The detection system 140 may succeed or fail to produce a match. It encodes that information with the response that it sends to the client through network connection 144. According to some embodiments, a failure response includes information about the reason for the failure. When fingerprint matching module 504 succeeds to find a match, the response generation module 506 provides relevant information to client 110 over network connection 144. What information is relevant varies across embodiments. Some examples of relevant information are the identity of the sampled content, the identity of the broadcast stream, and metadata relevant to the identified content, such as a link to the archived content or a link to a streaming program.

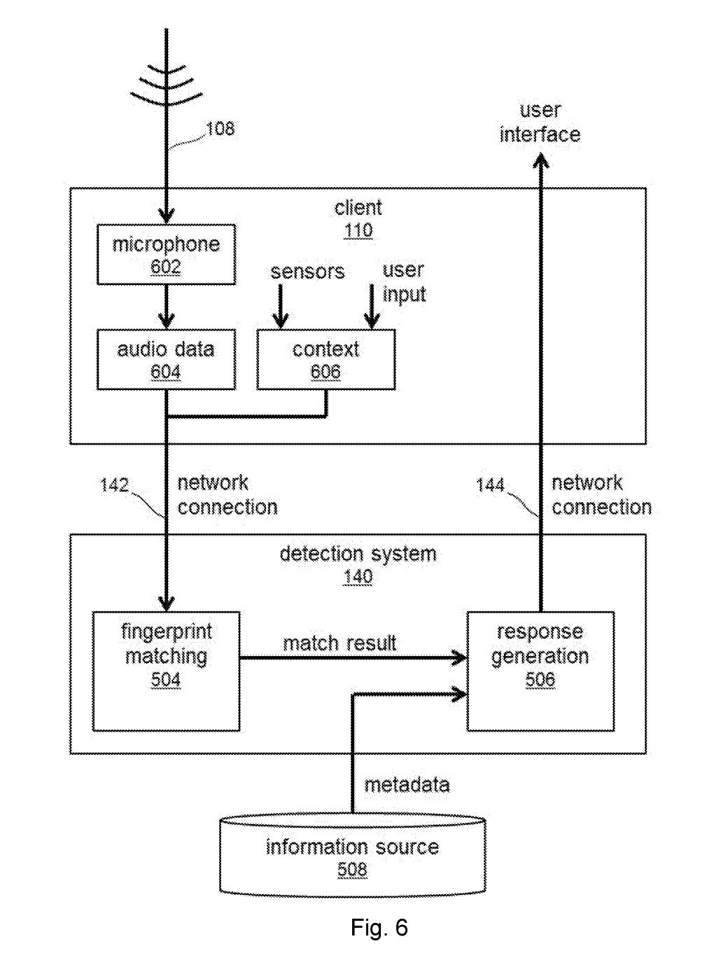

FIG. 6 shows a system operating with communication between client 110 and detection system 140. Client 110 receives audio signal 108 using its microphone sensor 602 and converts the audio signal to segments of audio data 604. Each segment is an appropriate size for making a fingerprint. Client 110 sends one or more segment as a query across network connection 142 to detection system 140. Client 110 also comprises context information 606, which acquires information from sensors, such as GPS, and user input, such as a profile configuration. According to an embodiment, client 110 may be triggered to transfer a query, including captured audio data and context information, across network connection 142 to detection system 140 in response to a request from the user. In some alternative embodiments, the client query may be triggered automatically at certain pre-determined or random time intervals or continuously.

Detection system 140 receives the query, computes a fingerprint from the segment of audio data, and performs fingerprint matching module 504 by comparing the computed fingerprint to those in a broadcast database. The fingerprint matching produces a match result sends it to response generation module 506. Response generation module 506 reads metadata from information source 508 and formats a response as appropriate for the client, which displays a corresponding response on a user interface. Responses to successful matches comprise a message with metadata from the broadcast database regarding the identity of the match. The identity of the match may include an ID of a broadcast station. It may also include the name of the program running on the broadcast station. It may also include the name of a song playing on the broadcast station. The information sent with the identity of the match can come from stored program schedule information or from information detected by the detection system. Responses to an unsuccessful fingerprint match indicate that. An unsuccessful match response, according to some embodiments, is, “Could not find a match”. An example of a successful match response for one particular use case is:

“Show Host: Terry Gross

Show Name: Fresh Air

Broadcasting Channel: WFPK 91.9 Radio Louisville

Show Time: 7-9 pm EST Wednesdays”

Various embodiments and various use cases produce different match results and metadata. For example, a radio station may offer special opportunities for concert tickets, as well as various promotions, ads and incentive programs, along with the station identification data. Other stations might have links to fund-raising opportunities and other URLs.

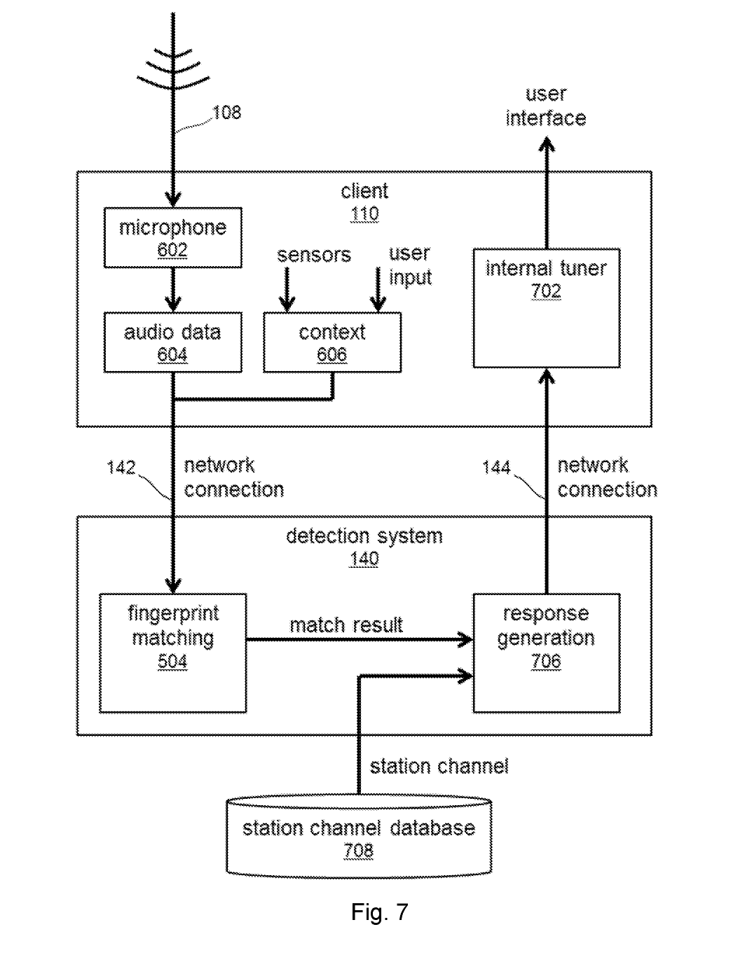

FIG. 7 shows an embodiment in which client 110 includes an internal tuner 702. Tuner 702 is able to tune to a radio or TV channel. Response generation module 706 users the match result from fingerprint matching module 504 to read station channel metadata from station channel database 708, which response generation module 706 includes station in its generated response to client 110. Client 110 may then use the station channel information to tune internal tuner 702 to the matched station channel. Internal tuner 702 provides audio and, in the case of a television channel match audio and video to the user interface along with a message such as, “Tuning to WFPK 91.9 Radio Louisville . . . ”. Internal tuner 702 can tune to a radio frequency, television channel, or to any other channel-based live broadcast content. Note that this embodiment can be implemented without identifying the show. All that's needed is the channel.

If audio signal 108 matches more than one database fingerprint, such as an HD version and an analog version of a radio station, the match result contains multiple station channels. Client 110 provides for the user to select one. In some embodiments, since some radio stations broadcast the same content on different frequencies from different towers with some overlap between their broadcasting range, client 110 may automatically select the strongest frequency with the strongest signal.

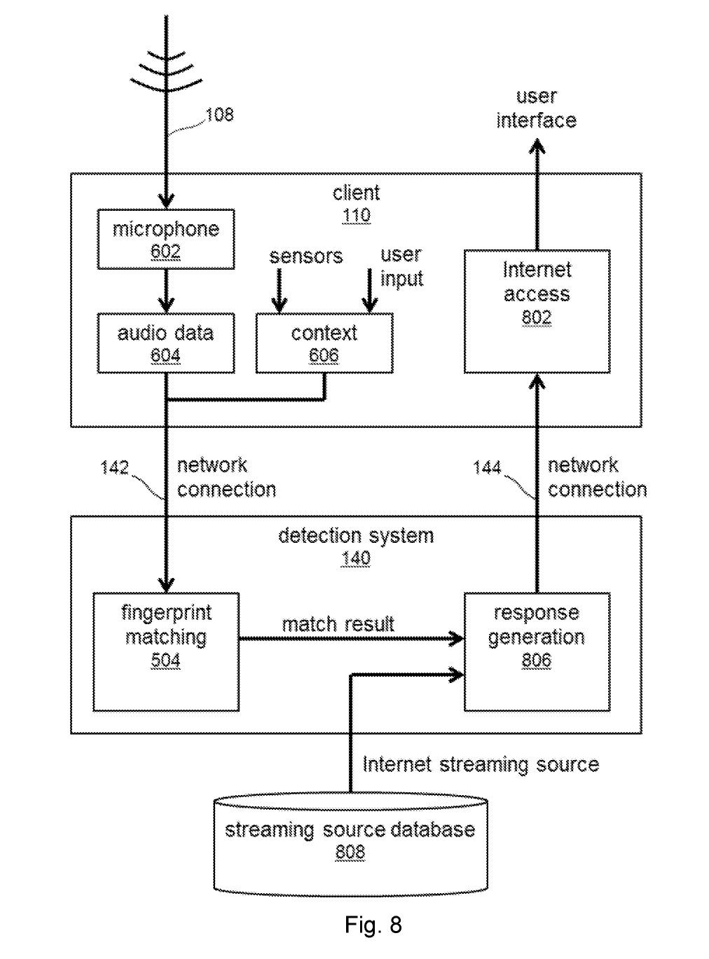

FIG. 8 shows an embodiment in which client 110 has Internet access 802 with the ability to receive a media stream from a URL. This may happen through a browser; for example, by accessing the live stream from a radio or television station from a webpage. Alternatively, an app associated with the specific station may give access to that specific station (e.g., KQED app). Response generation module 806 uses the match result of fingerprint matching module 504 to read an Internet streaming source URL from streaming source database 808, which response generation module 806 includes in its generated response to client 110. Client 110 uses Internet access 802 to simultaneously stream a copy of the live program. There may be a delay between the live signal (real-time reference) and the online stream. The online stream for a broadcast station is often close behind the live signal (e.g., at most a few seconds) and in that case, switching over for continued listening is practical. In some cases, the online stream can lag behind the live signal for up to a minute. This can cause a disconcerting repetition of program content. The Internet streaming URL may point to a live streamcast, such as an Internet radio channel, or to an archived program, if the detected program happened in the past or was first released on the Internet.

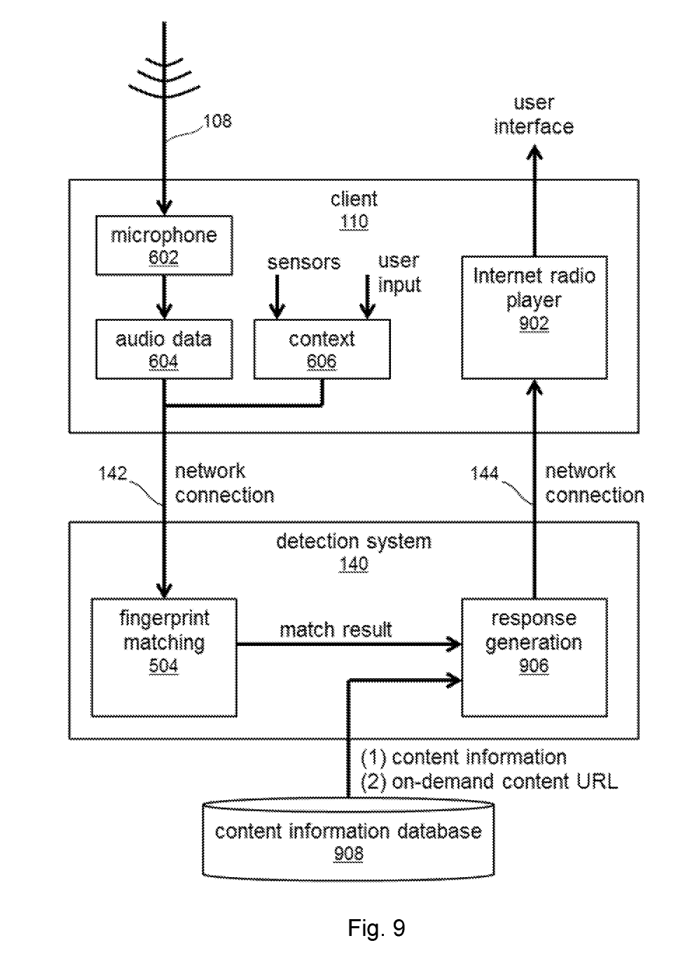

FIG. 9 shows an embodiment that uses a content information database 908 to look up content information and a URL for an on-demand Internet radio channel to continue the listening experience. Client 110 comprises Internet radio player 902. Response generation module 906 uses the result of fingerprint matching module 504 to look up: (1) content information metadata and (2) a URL of on-demand content from information database 908. Detection system 140 first provides the content information metadata to client 110. This information includes various metadata associated with the match result. At a later time, when the on-demand content is available, detection system 140 sends another response to client 110, the second response containing an on-demand content URL and updated information about the broadcast stream. In some embodiments, Internet radio player 902 is from a third party, and uses an app installed on the client; this works with a particular content source, such as iTunes, Hulu, or Netflix.

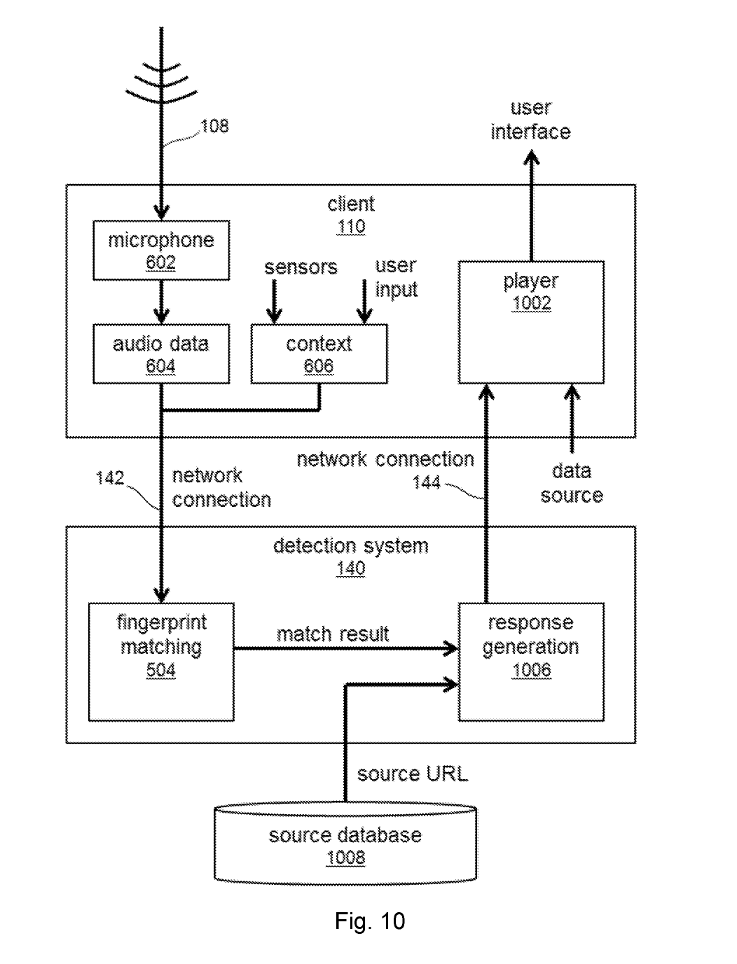

FIG. 10 shows an embodiment in which client 110 includes media player 1002. Response generation module 1006 uses the result of fingerprint matching module 504 to look up a source URL from media source database 1008. Media player 1002 retrieves the media from a data source, as directed by the URL, and plays the media on the user interface. In some embodiments, media player 1002 provides the user with playback controls, also called transport controls, such as buttons for pause, play, stop, fast forward, and rewind. In some embodiments, playback controls act on a remote source to control the received stream. In other embodiments, the player downloads a local copy of the data from the remote source, and the playback controls affect the use of the locally stored data.

In some embodiments, the data source is on the same server as the detection system. In some embodiments, the data source resides on a server closely associated with the detection system. In some embodiments the data source is not closely associated with the detection system.

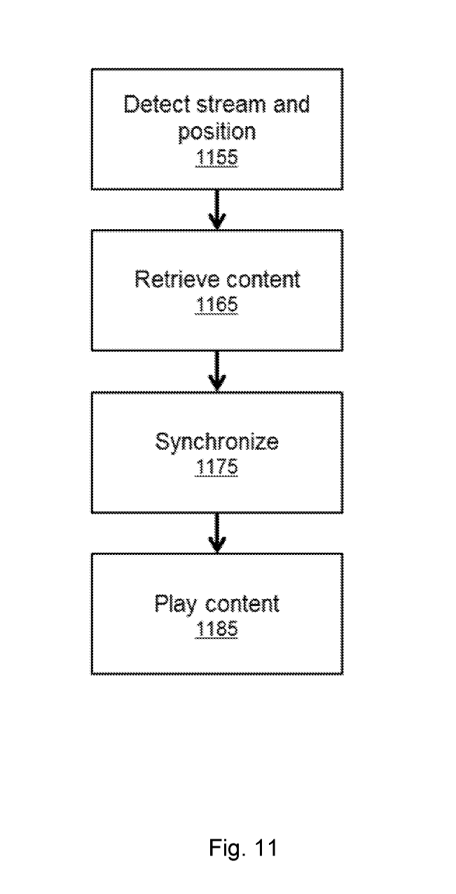

FIG. 11 shows a flow chart of an embodiment of the invention. Beginning at step 1155, detection system 140 matches the broadcast source of a stream of audio and the position of the match within the broadcast. If the audio is part of a recorded program with a beginning and end, detecting the source and position may include identifying a position within the program. Proceeding to step 1165, the detection system 140 may retrieve the content as a live stream, or as a recording. Proceeding to the synchronization step 1175, detection system 140 aligns the play position of the retrieved content with that of the client audio, by accessing the live stream or by retrieving the recording and finding the time within the recording corresponding to the detected position. Some embodiments choose a position within recordings that is earlier than the detected position. This allows a listener to review some of the program prior to the interruption in order to regain some context. Proceeding to step 1185, the client plays the retrieved content from the desired play position.

Note that a certain amount of time is required for broadcast monitoring system 120 to capture broadcast signals 102, and generate their fingerprints, for broadcast database 130 to receive and store the fingerprints, and for detection system 140 to retrieve the fingerprints from broadcast database 130. Therefore, for live broadcasts, it is necessary for client 110 or detection system 140 to allow a delay between the fingerprints of the client-side audio and the server-side audio fingerprints when fingerprint matching module 504 happens. A delay of 15 seconds is more than enough for most embodiments.

It should be noted that the process steps and instructions can be embodied in software, firmware or hardware, and when embodied in software, can be downloaded to reside on and be operated from different platforms used by a variety of operating systems.

The operations herein may also be performed by an apparatus. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims that follow.

What is claimed is:

1. A method for enabling the continuation of listening to a media broadcast stream, the method comprising:
maintaining a database of broadcast content comprising audio fingerprints from a plurality of monitored broadcast streams;
receiving from a client a query;
deriving an audio segment fingerprint from the query; and
comparing the audio segment fingerprint to content fingerprints from the database;
identifying an alternative source of content associated with the matching broadcast fingerprints; and
sending to the client identification information for at least one of the alternative sources of content.

2. The method of claim 1 wherein the source is a broadcast station.

3. The method of claim 1 wherein identifying an alternative source is partly based on metadata associated with the broadcast stream for the identified broadcast station.

4. The method of claim 1 further comprising the steps of:
identifying a timestamp assigned to the matching content fingerprints; and
providing the client information based on the identified timestamp sufficient to continue listening to the sampled audio content from a point of interruption.

5. The method of claim 1 further comprising the steps of providing the client a URL to access the sampled audio content over the internet.

6. The method of claim 1 further comprising:
failing to find a match; and
notifying the client of the failure.

7. The method of claim 1, wherein identifying a source comprises:
identifying multiple broadcast stations by detecting multiple content fingerprints that match the audio segment fingerprint, the multiple content fingerprints being from a plurality of broadcast stations; and
selecting one of the plurality of broadcast stations.

8. A detection system for providing users a continuing temporal experience, the detection system comprising:
a network connection for receiving client data from a client;
a module for comparing an audio segment fingerprint to a number of broadcast content fingerprints in a broadcast database; and
a module for generating a response to a client based on the result of a comparison.

9. The detection system of claim 8 wherein the client data comprises an audio segment, the detection system further comprising a module for creating an audio segment fingerprint from the audio segment.

10. The detection system of claim 8 wherein the client data comprises an audio segment fingerprint.

11. The detection system of claim 8 wherein the response comprises:
a URL indicating the location of a broadcast stream; and
a timestamp indicating a time position within the broadcast stream.

12. At least one non-transitory computer readable medium storing code that, if executed by one or more computer processors, would cause the one or more computer processors to:
capture an audio segment from a microphone;
use a network connection to send data representative of the audio segment to a detection system;
receive a response from the detection system.

13. The at least one non-transitory computer readable medium of claim 12 wherein the code, if executed by one or more computer processors, would further cause the one or more computer processors to tune an internal tuner to a station indicated by the response.

14. The at least one non-transitory computer readable medium of claim 12 wherein the code, if executed by one or more computer processors, would further cause the one or more computer processors to play a broadcast stream from a URL indicated by the response.
